(19) United States
(12) Patent Application Publication
(10) Pub. No.: US 2024/0016228 A1
(43) Pub. Date: Jan. 18, 2024

(54) ELECTRONIC-CIGARETTE VAPORIZATION CORE AND ELECTRONIC CIGARETTE

(71) Applicant: BYD PRECISION MANUFACTURE CO., LTD., Shenzhen (CN)

(72) Inventors: Pinyi JIANG, Shenzhen (CN); Yonghe HUANG, Shenzhen (CN); Tianyou DENG, Shenzhen (CN); Xinping LIN, Shenzhen (CN)

(21) Appl. No.: 18/476,332

(22) Filed: Sep. 28, 2023

Related U.S. Application Data
(63) Continuation of application No. PCT/CN2021/126489, filed on Oct. 26, 2021.

(30) Foreign Application Priority Data
Jun. 3, 2021 (CN) 202121256660.8

(51) Int. Cl. A24F 40/485; A24F 40/10; A24F 40/42; A24F 40/46

(52) U.S. Cl. CPC A24F 40/485; A24F 40/10; A24F 40/42; A24F 40/46

(57) ABSTRACT

Embodiments of the present disclosure provide an electronic-cigarette vaporization core and an electronic cigarette. The electronic-cigarette vaporization core includes a porous body and a heating element. The porous body includes an e-liquid absorption end and a vaporization end. The heating element is arranged at the vaporization end of the porous body. The porous body includes a first porous body and a second porous body. A groove is provided on a surface of the first porous body close to the e-liquid absorption end. The second porous body is partially or completely embedded in the groove. A thermal shrinkage difference between the first porous body and the second porous body is less than 2%.

### CROSS-REFERENCE TO RELATED APPLICATIONS

This application is a continuation of International Application No. PCT/CN2021/126489, filed on Oct. 26, 2021, which claims priority to and benefits of Chinese Patent Application No. 202121256660.8, filed on Jun. 3, 2021. The entire content of the above-referenced application is incorporated herein by reference.

### FIELD

The present disclosure relates to the technical field of vaporization devices, and specifically to an electronic-cigarette vaporization core and an electronic cigarette.

### BACKGROUND

A vaporization core is an important part of an electronic vaporization device, and mainly includes a porous body and a heating element arranged on a surface of the porous body. The porous body is communicated with an e-liquid storage cavity storing a to-be-vaporized e-liquid, and can conduct the to-be-vaporized e-liquid to the heating element. The to-be-vaporized e-liquid is vaporized after being heated by the heating element.

Chinese Patent Application No. CN201711311466.3 discloses a vaporizer, where a groove is provided on a surface of an e-liquid absorption end of the porous body to improve the e-liquid guiding efficiency of the porous body. However, the groove provided on the surface of the e-liquid absorption end of the porous body makes the porous body prone to deformation and warping during sintering, resulting in the deformation of the surface of the ceramic porous body. When the heating element is arranged on the surface of the porous body, the circuit of the heating element may have an uneven thickness, affecting the vaporization effect of the vaporization core.

### SUMMARY

An objective of the present disclosure is to provide new technical solutions of an electronic-cigarette vaporization core and an electronic cigarette.

A first aspect of the present disclosure provides an electronic-cigarette vaporization core, including: a porous body and a heating element, the porous body including an e-liquid absorption end and a vaporization end, and the heating element being arranged at the vaporization end of the porous body;
the porous body including a first porous body and a second porous body, a groove being provided on a surface of the first porous body close to the e-liquid absorption end, and the second porous body being partially or completely embedded in the groove; and
a thermal shrinkage difference between the first porous body and the second porous body being less than 2%.

According to an embodiment of the present disclosure, the second porous body is completely embedded in the groove on the first porous body, the second porous body matches the groove, and the second porous body completely fills the groove.

According to an embodiment of the present disclosure, the thermal shrinkage difference between the first porous body and the second porous body is less than 0.5%.

According to an embodiment of the present disclosure, a thermal shrinkage of the first porous body ranges from 1% to 22%, and a thermal shrinkage of the second porous body ranges from 1% to 22%.

According to an embodiment of the present disclosure, the first porous body and the second porous body are identical porous ceramic bodies.

According to an embodiment of the present disclosure, the groove includes a central groove and at least one cross groove located on an outer side of the central groove, and the at least one cross groove is communicated with the central groove.

According to an embodiment of the present disclosure, a quantity of the at least one cross grooves is two, and the two cross grooves are symmetrically arranged on two sides of the central groove.

According to an embodiment of the present disclosure, the first porous body is provided with an air guide channel, and the air guide channel is a through hole running through the first porous body along an extending direction from the e-liquid absorption end to the vaporization end.

According to an embodiment of the present disclosure, the first porous body is provided with an air guide channel, the air guide channel is a through groove arranged on an outer surface of the first porous body, and the through groove runs through the first porous body along an extending direction from an e-liquid absorption surface to a vaporization surface.

According to an embodiment of the present disclosure, a pore size of the first porous body ranges from 5 μm to 100 μm, and a pore size of the second porous body ranges from 5 μm to 100 μm; and
a porosity of the first porous body ranges from 45% to 65%, and a porosity of the second porous body ranges from 45% to 65%.

According to an embodiment of the present disclosure, a volume of the second porous body accounts for 1%-70% of a total volume of the porous body.

According to an embodiment of the present disclosure, a volume of the second porous body accounts for 3%-50% of a total volume of the porous body.

According to an embodiment of the present disclosure, the heating element includes an electrically conductive heating circuit, a first electrode, and a second electrode, the electrically conductive heating circuit is arranged on a surface of the vaporization end of the porous body, and the first electrode and the second electrode are electrically connected to the electrically conductive heating circuit.

According to an embodiment of the present disclosure, a crushing strength of the electronic-cigarette vaporization core is greater than or equal to 410 N.

A second aspect of the present disclosure provides an electronic cigarette, including the electronic-cigarette vaporization core according to the first aspect.

According to an embodiment of the present disclosure, the electronic cigarette further includes a housing, an e-liquid storage bin, an upper bracket, a lower bracket, and a lower cover, where the upper bracket, the electronic-cigarette vaporization core, and the lower bracket are arranged between the housing and the lower cover, an outlet passage is arranged on the housing, an air exit hole communicated with the outlet passage and an e-liquid guide hole communicated with the e-liquid storage bin are provided on the upper bracket, the electronic-cigarette vaporization core is located between the upper bracket and the lower bracket, the e-liquid storage bin is communicated with the e-liquid absorption end of the porous body through the e-liquid guide hole, a vaporization chamber is formed between the vaporization end of the porous body and the lower bracket, the lower cover is located on a side of the lower bracket away from the electronic-cigarette vaporization core, an air intake hole is provided on the lower cover, and the air intake hole is communicated with the air exit hole through the vaporization chamber.

According to an embodiment of the present disclosure, the electronic cigarette further includes an upper-bracket sealing element, a vaporization-core sealing element, and a lower-cover sealing element, where the upper-bracket sealing element is sleeved on an outer periphery of the upper bracket, an outer edge of the upper-bracket sealing element abuts against an inner wall of the housing to define the e-liquid storage bin, the upper-bracket sealing element is provided with a first communication hole for communicating the e-liquid storage bin with the e-liquid guide hole, and the upper-bracket sealing element is provided with a second communication hole for communicating the outlet passage with the air exit hole; the vaporization-core sealing element is sleeved on an outer periphery of the electronic-cigarette vaporization core; and the lower-cover sealing element is arranged around an outer periphery of the lower cover, and an outer edge of the lower-cover sealing element abuts against an inner wall of the housing.

One technical effect of the embodiments of the present disclosure is as follows.

The porous body of the electronic-cigarette vaporization core provided in the embodiments of the present disclosure includes the e-liquid absorption end and the vaporization end. The heating element is arranged at the vaporization end of the porous body. The second porous body is partially or completely embedded in the groove. The thermal shrinkage difference between the first porous body and the second porous body is less than 2%. Therefore, the first porous body and the second porous body can maintain a high surface flatness, and the combination of the first porous body and the second porous body can improve the structural strength and the deformation resistance of the electronic-cigarette vaporization core.

Other features and advantages of the present disclosure will become apparent from the following detailed description of exemplary embodiments of the present disclosure with reference to the drawings.

### BRIEF DESCRIPTION OF THE DRAWINGS

Accompanying drawings are incorporated into and constitute a part of this specification, show embodiments that conform to this application, and are used together with this specification to describe the principle of this application.

FIG. 1 is a schematic diagram of an overall structure of an electronic-cigarette vaporization core according to an embodiment of the present disclosure;

FIG. 2 is a cross-sectional view of a second porous body of an electronic-cigarette vaporization core according to an embodiment of the present disclosure;

FIG. 3 is a top view of a second porous body of an electronic-cigarette vaporization core according to an embodiment of the present disclosure;

FIG. 4 is a cross-sectional view taken along plane A-A in FIG. 3;

FIG. 5 is a front view of an electronic-cigarette vaporization core according to an embodiment of the present disclosure;

FIG. 6 is a side view of an electronic-cigarette vaporization core according to an embodiment of the present disclosure;

FIG. 7 is a bottom view of an electronic-cigarette vaporization core according to an embodiment of the present disclosure;

FIG. 8 is an exploded view of an electronic cigarette according to an embodiment of the present disclosure; and

FIG. 9 is a cross-sectional view of an electronic cigarette according to an embodiment of the present disclosure.

In the drawings: 100—electronic-cigarette vaporization core; 200—e-liquid absorption end; 300—vaporization end; 1—first porous body; 11—groove; 111—central groove; 112—cross groove; 12—through groove; 2—second porous body; 21—e-liquid absorption groove; 3—electrically conductive heating circuit; 1001—outer surface;

101—housing; 1011—outlet passage; 102—e-liquid storage bin; 103—upper bracket; 1031—air exit hole; 1032—e-liquid guide hole; 104—lower bracket; 105—lower cover; 1051—air intake hole; 106—vaporization chamber; 107—upper-bracket sealing element; 1071—first communication hole; 1072—second communication hole; 108—vaporization-core sealing element; 109—lower-cover sealing element; 1010—e-liquid absorption element.

### DETAILED DESCRIPTION

Various exemplary embodiments of this application are now be described in detail with reference to the accompanying drawings. It should be noted that unless otherwise specified, opposite arrangement, numerical expressions, and numerical values of components and steps described in the embodiments do not limit the scope of the present disclosure.

The following descriptions of at least one exemplary embodiment are merely illustrative, and in no way constitute any limitation on this application and application or use of this application.

Technologies, methods, and devices known to those of ordinary skill in related arts may not be discussed in detail, but where appropriate, the techniques, the methods, and the devices should be considered as a part of the specification.

In all examples shown and discussed herein, any specific value should be construed as merely exemplary and not as limitations. Therefore, other examples of exemplary embodiments may have different values.

It should be noted that like numerals and letters denote like terms in the following drawings. Therefore, once an item is defined in one accompanying drawing, the item does not need to be further discussed in the subsequent accompanying drawings.

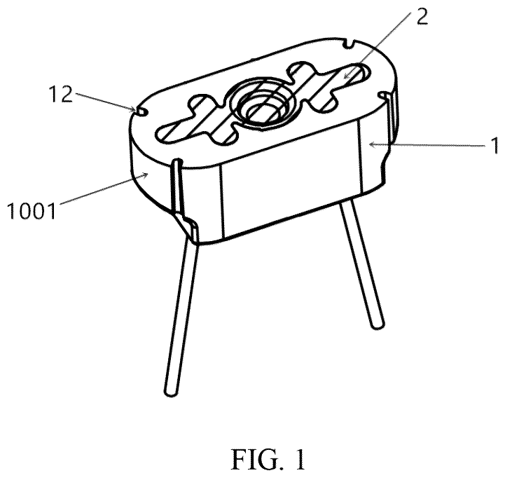

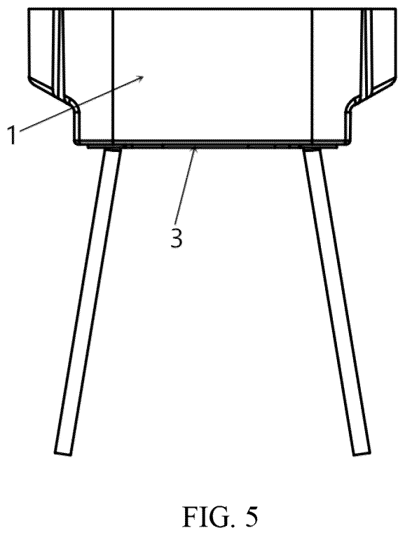

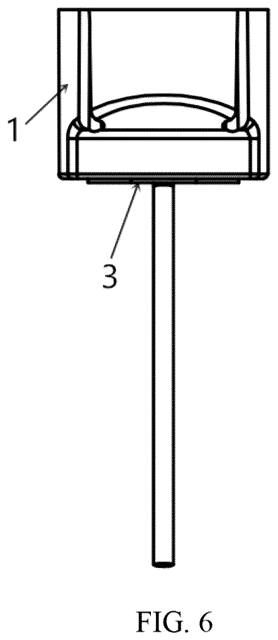

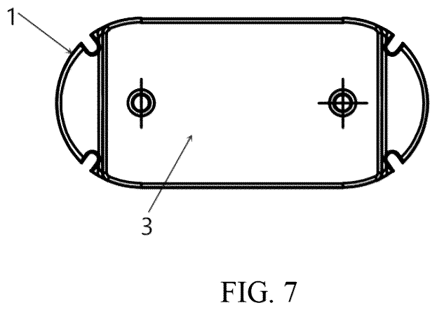

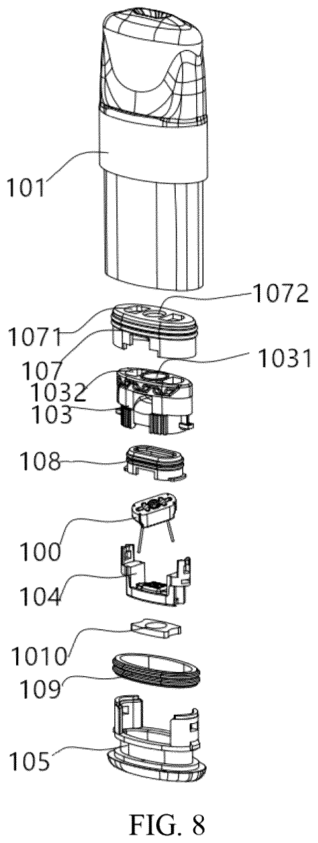

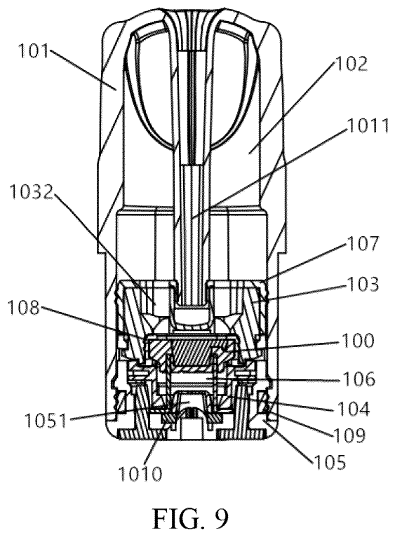

Referring to FIG. 1 to FIG. 7, an embodiment of the present disclosure provides an electronic-cigarette vaporization core 100. The electronic-cigarette vaporization core 100 includes a porous body and a heating element. The porous body includes an e-liquid absorption end 200 and a vaporization end 300. The heating element is arranged at the vaporization end 300 of the porous body.

The porous body includes a first porous body 1 and a second porous body 2. A groove 11 is provided on a surface of the first porous body 1 close to the e-liquid absorption end 200. The second porous body 2 is partially or completely embedded in the groove 11.

A thermal shrinkage difference between the first porous body 1 and the second porous body 2 is less than 2%. According to an embodiment of the present disclosure, the thermal shrinkage difference between the first porous body 1 and the second porous body 2 is less than 0.5%.

According to an embodiment of the present disclosure, the second porous body 2 may be partially embedded in the groove 11 or may be completely embedded in the groove 11, so that the structural strength and deformation resistance of the electronic-cigarette vaporization core 100 can be enhanced while improving the surface flatness of the porous body.

The thermal shrinkage difference between the first porous body 1 and the second porous body 2 is small. Specifically, a material used by the first porous body 1 is similar to a material used by the second porous body 2, so that a thermal shrinkage difference between the material used by the first porous body 1 and the material used by the second porous body 2 is small. Alternatively, the material used by the first porous body 1 is completely the same as the material used by the second porous body 2. Alternatively, both the material used by the first porous body 1 and the material used by the second porous body 2 are existing ceramic materials, such as existing alumina ceramics or silicon oxide ceramics. According to an embodiment of the present disclosure, the first porous body 1 and the second porous body 2 are made of the same ceramic material, i.e., the first porous body 1 and the second porous body 2 are identical porous ceramic bodies. The thermal shrinkage degrees of the first porous body 1 and the second porous body 2 are close or the same, which further increases the resistance of the first porous body 1 and the second porous body 2 to shrinkage deformation, thereby effectively reducing the deformation degree of the first porous body 1 and the second porous body 2, and improving the surface flatness of the first porous body 1 and the second porous body 2. The flatness refers to a deviation of a macroscopic concave-convex height of the surface of the porous body from an ideal plane. For example, the flatness of the vaporization end 300 is less than or equal to 80 μm, so that a surface grinding process for the first porous body 1 and the second porous body 2 is omitted, thereby greatly reducing the production costs. In addition, a higher flatness of the surface of the vaporization end 300 of the porous body indicates a more uniform arrangement of the heating element on the surface of the vaporization end 300 and a better vaporization effect of the vaporization core.

In the related art, a groove structure may be arranged on the surface of the e-liquid absorption end 200 of the porous body to improve the e-liquid guiding efficiency of the porous body. However, the arrangement of the groove structure reduces the structural strength of the porous body, and the porous body is prone to deformation. In the related art, the porous body may be prepared by integral injection molding. The prepared porous body is also prone to warping deformation due to large differences between injection densities of difference regions of the blank during the injection molding process. When the porous body is warped and deformed, and the heating element is arranged on the surface of the vaporization end 300 of the porous body, the heating circuit is likely to have an uneven thickness, resulting in a poor heating effect. In addition, e-liquid leakage is likely to occur during assembly due to the uneven outer contour. The porous body of the electronic-cigarette vaporization core 100 provided in the embodiments of the present disclosure includes the e-liquid absorption end 200 and the vaporization end 300. The heating element is arranged at the vaporization end 300 of the porous body. The second porous body 2 is partially or completely embedded in the groove 11. With the arrangement of the porous body as two parts engaged with each other and the setting of the first porous body 1 and the second porous body 2 to have a thermal shrinkage difference of less than 2%, the injection molding density in the blank can be reasonably distributed, so that the differences between injection molding densities of different regions of the blank in the injection molding process can be reduced, thereby reducing the deformation of the porous body in the sintering process. In addition, the small thermal shrinkage difference between the first porous body 1 and the second porous body 2 can further reduce the deformation of the porous body during sintering, and can enable the first porous body 1 and the second porous body 2 to maintain a high surface flatness after molding, so as to improve the structural strength and deformation resistance of the electronic-cigarette vaporization core 100 and ensure the structural stability of the electronic-cigarette vaporization core 100.

According to an embodiment of the present disclosure, the second porous body 2 is completely embedded in the groove on the first porous body, the second porous body matches the groove, and the second porous body completely fills the groove. That is, the shape of the second porous body completely matches the shape of the groove of the first porous body.

Specifically, the matching of the second porous body 2 with the groove 11 may be understood to mean that a top surface of the second porous body 2 and a top surface of the first porous body 1 are in the same plane after the second porous body 2 is completely embedded in the groove 11 of the first porous body 1. The top surface of the second porous body 2 may specifically be a side surface of the second porous body 2 away from the first porous body 1, that is, a side surface close to the e-liquid absorption end 200. The top surface of the first porous body 1 is a side surface of the first porous body 1 close to the e-liquid absorption end 200. In this way, the second porous body 2 and the first porous body 1 are combined to form a regular porous body structure, thereby avoiding the formation of an obvious uneven structure on the porous body and ensuring the structural strength and integrity of the electronic-cigarette vaporization core 100.

According to an embodiment of the present disclosure, the thermal shrinkage difference between the first porous body 1 and the second porous body 2 is less than 0.5%. A smaller thermal shrinkage difference between the first porous body 1 and the second porous body 2 indicates that the prepared porous body is less likely to warp and deform, and indicates higher vaporization efficiency of the obtained vaporization core.

In some implementations of the present disclosure, a thermal shrinkage of the first porous body 1 ranges from 1% to 22%. According to an embodiment of the present disclosure, the thermal shrinkage of the first porous body 1 ranges from 12% to 22%. A thermal shrinkage of the second porous body 2 ranges from 1% to 22%. According to an embodiment of the present disclosure, the thermal shrinkage of the second porous body 2 ranges from 12% to 22%.

Specifically, when the thermal shrinkages of the first porous body 1 and the second porous body 2 are close or the same, the first porous body 1 and the second porous body 2 may specifically be made of existing materials having similar or same thermal shrinkages, which can effectively reduce the deformation degree of the first porous body 1 and the second porous body 2 while increasing the resistance of the first porous body 1 and the second porous body 2 to shrinkage deformation, thereby improving the surface flatness of the first porous body 1 and the second porous body 2. When the thermal shrinkages of the first porous body 1 and the second porous body 2 are too small, a large stress will be generated inside the first porous body 1 and the second porous body 2, leading to a reduced structural stability of the porous body. When the thermal shrinkages of the first porous body 1 and the second porous body 2 are too large, the excessive deformation of the first porous body 1 and the second porous body 2 reduces the structural strength and appearance uniformity of the porous body.

In some implementations of the present disclosure, the first porous body 1 and the second porous body 2 are porous ceramic bodies.

According to an embodiment of the present disclosure, the first porous body 1 and the second porous body 2 are identical porous ceramic bodies. The porous ceramic body is a conventional porous ceramic body in the field of electronic-cigarette vaporization cores.

In some implementations of the present disclosure, the first porous body 1 is provided with an air guide channel, and the air guide channel is a through hole running through the first porous body along an extending direction from the e-liquid absorption end 200 to the vaporization end 300.

According to some embodiments of the present disclosure, the first porous body 1 is provided with an air guide channel, the air guide channel is a through groove 12 arranged on an outer surface 1001 of the first porous body 1, and the through groove 12 runs through the first porous body 1 along an extending direction from an e-liquid absorption surface to a vaporization surface, as shown in FIG. 1.

One end of the air guide channel may be communicated with an e-liquid storage bin of an electronic cigarette, and another end of the air guide channel may be communicated with the atmosphere. The air guide channel provides a one-way guiding effect to allow entrance of outside air and prevent the leakage of e-liquid in the e-liquid storage bin.

During the operation of an electronic cigarette using the electronic-cigarette vaporization core 100, an e-liquid enters the porous body from the e-liquid absorption end 200 of the porous body, and is vaporized into an aerosol under the heating action of the heating element and discharged from the vaporization end 300 of the porous body. As the e-liquid is continuously vaporized and consumed, the e-liquid storage bin may enter a negative pressure state. In this case, outside air needs to be introduced to the e-liquid absorption end 200 to restore a balance between internal and external pressures. The introduction of air into the e-liquid absorption end 200 of the porous body through the air guide channel achieves a good air replenishing effect, so that the e-liquid can be continuously supplied to the porous body under the action of a capillary force of the porous body, gravity, and negative pressure of suction, thereby avoiding the problems of discontinuous e-liquid supply and dry heating.

It should be noted that, “one-way guiding” may be realized by different structures. For example, one-way guiding may be realized by arranging a one-way valve, by using an external structure such as an air-permeable and liquid-impermeable membrane, by adjusting the diameter of the air guide channel, or by designing the shape of the air guide channel, for example, into a shape having multiple bends.

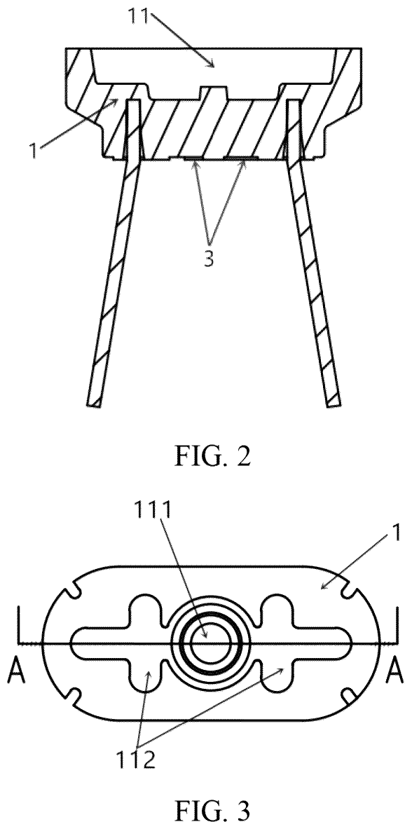

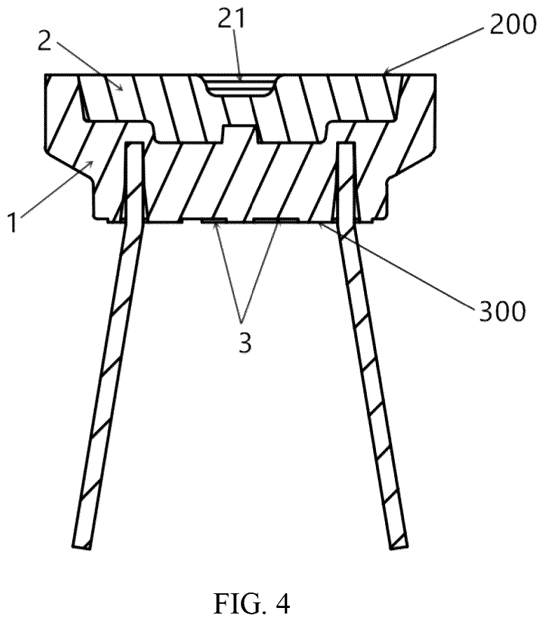

In some implementations of the present disclosure, referring to FIG. 2 and FIG. 3, the groove 11 includes a central groove 111 and at least one cross groove 112 located on an outer side of the central groove 111, the at least one cross groove 112 is communicated with the central groove 111, and the second porous body 2 is embedded in the central groove 111 and the at least one cross groove 112.

Specifically, after the at least one cross groove 112 is arranged on the outer side of the central groove 111, the deformation of the porous body can be further reduced. The structure of the at least one cross groove 112 can effectively reduce the shrinkage stress difference between the inside and outside of the porous body, thereby ensuring the morphological stability of the electronic-cigarette vaporization core 100, and ensuring the flatness of the heating element in the subsequent screen printing process. In addition, compared with the design of a single groove, the arrangement of the at least one cross groove 112 can effectively improve the overall strength of the porous body.

In some implementations of the present disclosure, referring to FIG. 3, a quantity of the at least one cross grooves 112 is two, and the two cross grooves 112 are symmetrically arranged on two sides of the central groove 111.

Specifically, a cross section of the porous body perpendicular to the flow direction of the e-liquid may be of an elongated structure with rounded corners at two ends. When the quantity of the at least one cross grooves 112 is two, and the two cross grooves 112 are symmetrically arranged on the two sides of the central groove 111, the area of the e-liquid absorption end 200 can be fully utilized, thereby improving e-the liquid absorption efficiency of the electronic-cigarette vaporization core 100. In addition, if the cross section of the porous body is circular, the quantity of the at least one cross grooves 112 may be set to three or more, and the cross grooves 112 surround an outer periphery of the central groove 111.

In some implementations of the present disclosure, referring to FIG. 4, the second porous body 2 is provided with an e-liquid absorption groove 21 at a position corresponding to the central groove 111. A cross section of the e-liquid absorption groove 21 may be circular, and the arrangement of the e-liquid absorption groove 21 on the second porous body 2 can increase the contact area between the second porous body 2 and the e-liquid, thereby improving the infiltration efficiency of the e-liquid.

In some implementations of the present disclosure, a pore size of the first porous body 1 ranges from 5 μm to 100 μm, and a pore size of the second porous body 2 ranges from 5 μm to 100 μm.

A porosity of the first porous body 1 ranges from 45% to 65%, and a porosity of the second porous body 2 ranges from 45% to 65%.

Specifically, the pore size of the first porous body 1 ranges from 5 μm to 100 μm, including but not limited to, 5 μm, 10 μm, 20 μm, 30 μm, 80 μm or 100 μm. The pore size of the second porous body 2 ranges from 5 μm to 100 μm, including but not limited to 5 μm, 10 μm, 20 μm, 30 μm, 80 μm or 100 μm. The porosity of the first porous body 1 ranges from 45% to 65%, including but not limited to 45%, 50%, 55%, 60% or 65%. The porosity of the second porous body 2 ranges from 45% to 65%, including but not limited to 45%, 50%, 55%, 60% or 65%. The pore size of the first porous body 1 and the pore size of the second porous body 2 may be the same or different. The porosity of the first porous body 1 and the porosity of the second porous body 2 may be the same or different. When the pore size and porosity of the first porous body 1 are in the above ranges, the first porous body 1 can have a larger e-liquid storage capacity and can quickly transfer the to-be-vaporized e-liquid to the second porous body 2, thereby ensuring a higher transfer rate of the to-be-vaporized e-liquid. When the pore size and porosity of the second porous body 2 are in the above ranges, the to-be-vaporized e-liquid can be converted into fine droplets, to achieve a good vaporization effect.

In some implementations of the present disclosure, a volume of the second porous body 2 accounts for 1%-70% of a total volume of the porous body.

Specifically, when the volume of the second porous body 2 accounts for 1%-70% of the total volume, i.e., when the volume of the first porous body 1 accounts for 30%-99% of the total volume, because the first porous body 1 and the second porous body 2 are both porous structures, the internal and external stresses of the porous body can be reduced by arranging the porous body as a multilayer embedding structure including the first porous body 1 and the second porous body 2, thereby reducing the deformation of the porous body. That is, by controlling the volumes of the first porous body and the second porous body to be within the above ranges, the porous body has a small deformation and a high flatness. According to an embodiment of the present disclosure, the volume of the second porous body 2 accounts for 3%-50% of the total volume of the porous body, in which case the porous body has higher deformation resistance and higher flatness.

In some implementations of the present disclosure, the heating element includes an electrically conductive heating circuit 3, a first electrode, and a second electrode. The electrically conductive heating circuit 3 is arranged on a surface of the vaporization end 300 of the porous body.

Specifically, the electrically conductive heating circuit 3 is arranged on a surface of the vaporization end 300 of the first porous body 1, and the first electrode and the second electrode are electrically connected to the electrically conductive heating circuit 3. The first electrode and the second electrode are electrically connected to a positive electrode and a negative electrode of a power supply. A current is generated in the electrically conductive heating circuit 3. When electric energy in the electrically conductive heating circuit 3 is converted into heat energy, the e-liquid at the vaporization end 300 can be effectively vaporized to ensure the vaporization effect of the electronic-cigarette vaporization core 100.

In some implementations of the present disclosure, a crushing strength of the electronic-cigarette vaporization core 100 is greater than or equal to 410 N.

Specifically, when the second porous body 2 fills the groove 11 of the first porous body 1, the first porous body 1 and the second porous body 2 may form a complete porous body structure, so that the internal and external stresses of the porous body can be reduced, thereby reducing the deformation of the porous body.

In the electronic-cigarette vaporization core in the present disclosure, a power supply component is used to supply power to the first electrode and the second electrode, so that a current is generated in the electrically conductive heating circuit 3. When the electric energy in the electrically conductive heating circuit 3 is converted into heat energy, the e-liquid at the vaporization end 300 can be effectively vaporized to ensure the vaporization effect of the electronic-cigarette vaporization core 100.

Another embodiment of the present disclosure further provides an electronic cigarette, including the electronic-cigarette vaporization core.

In some implementations of the present disclosure, the electronic cigarette further includes a housing 101, an e-liquid storage bin 102, an upper bracket 103, a lower bracket 104, and a lower cover 105. The upper bracket 103, the electronic-cigarette vaporization core 100, and the lower bracket 104 are arranged between the housing 101 and the lower cover 105. An outlet passage 1011 for leading out an aerosol obtained through heating and vaporization by the electronic-cigarette vaporization core is arranged on the housing 101. An air exit hole 1031 communicated with the outlet passage 1011 and an e-liquid guide hole 1032 communicated with the e-liquid storage bin 102 are provided on the upper bracket 103. The electronic-cigarette vaporization core 100 is located between the upper bracket 103 and the lower bracket 104. The e-liquid storage bin 102 is communicated with the e-liquid absorption end 200 of the porous body through the e-liquid guide hole 1032. A vaporization chamber 106 is formed between the vaporization end 300 of the porous body and the lower bracket 104. The lower cover 105 is located on a side of the lower bracket 104 away from the electronic-cigarette vaporization core 100. An air intake hole 1051 is provided on the lower cover 105. The air intake hole 1051 is communicated with the air exit hole 1031 through the vaporization chamber 106.

Specifically, when the electronic cigarette operates, the e-liquid flowing out of the e-liquid storage bin 102 is guided to the e-liquid absorption end 200 of the porous body through the e-liquid guide hole 1032, absorbed to the heating element at the vaporization end 300 of the porous body under a capillary action of the porous body, and heated and vaporized into an aerosol by the heating element. In this case, when a user vapes through the outlet passage 1011, air in the air intake hole 1051 is driven to flow into the vaporization chamber 106, and carry the aerosol in the vaporization chamber 106 to the outlet passage 1011. As the e-liquid is continuously absorbed by the porous body and supplied to the heating element, a negative pressure is formed in the e-liquid storage bin 102. Under the negative pressure, outside air can enter the e-liquid guide hole 1032 and the e-liquid storage bin 102 through the vaporization chamber 106 to form an air pressure balance and ensure that the e-liquid can be smoothly introduced into the porous body.

In some implementations of the present disclosure, the electronic cigarette further includes an upper-bracket sealing element 107, a vaporization-core sealing element 108, and a lower-cover sealing element 109. The upper-bracket sealing element 107 is sleeved on an outer periphery of the upper bracket 103. An outer edge of the upper-bracket sealing element 107 abuts against an inner wall of the housing 101 to define the e-liquid storage bin 102. The upper-bracket sealing element 107 is provided with a first communication hole 1071 for communicating the e-liquid storage bin 102 with the e-liquid guide hole 1032. The upper-bracket sealing element 107 is provided with a second communication hole 1072 for communicating the outlet passage 1011 with the air exit hole 1031. The vaporization-core sealing element 108 is sleeved on an outer periphery of the electronic-cigarette vaporization core 100. An inner wall of the vaporization-core sealing element 108 and the through groove 12 of the outer surface 1001 of the first porous body jointly form the air guide channel. An outer edge of the vaporization-core sealing element 108 abuts against an inner wall of the upper bracket 103. The lower-cover sealing element 109 is arranged around an outer periphery of the lower cover 105, and an outer edge of the lower-cover sealing element 109 abuts against an inner wall of the housing 101.

Specifically, the upper-bracket sealing element 107, the vaporization-core sealing element 108, and the lower-cover sealing element 109 are used for providing necessary sealing performance inside the electronic cigarette, to avoid unnecessary communication between the e-liquid storage bin 102 and connection gaps between the elements, thereby effectively avoiding e-liquid leakage. In addition, the electronic cigarette further includes an e-liquid absorption element 1010. The e-liquid absorption element 1010 is arranged around an outer periphery of the air intake hole 1051. The e-liquid absorption element 1010 is configured to absorb a condensate flowing out of the air intake hole 1051.

The present disclosure is further described below with reference to examples and comparative examples.

### Example 1

This example is used for explaining an electronic-cigarette vaporization core disclosed in the present disclosure. The electronic-cigarette vaporization core includes a porous body and a heating element. The porous body includes an e-liquid absorption end configured for contact with an e-liquid and a vaporization end for providing an aerosol. The porous body includes a first porous body and a second porous body. The first porous body is provided with a groove at the e-liquid absorption end. The groove includes a central groove and two cross grooves located on two sides of the central groove. The two cross grooves are respectively communicated with the central groove. The second porous body is embedded in the central groove and the cross grooves. The second porous body is provided with an e-liquid absorption groove corresponding to the central groove.

An electrically conductive heating circuit is arranged on a surface of the vaporization end of the porous body. The electrically conductive heating circuit is obtained by screen printing a metal slurry on the surface of the porous body. A first electrode and a second electrode are partially inserted into the porous body. The first electrode and the second electrode are electrically connected to the electrically conductive heating circuit.

The material of the second porous body is the same as that of the first porous body. In the total volume of the first porous body and the second porous body, the second porous body accounts for 50%, and the first porous body accounts for 50%.

### Example 2

The materials of the first porous body and the second porous body are the same as that of the first porous body in Example 1.

A difference lies in that in the total volume of the first porous body and the second porous body, the second porous body accounts for 20%, and the first porous body accounts for 80%.

### Comparative Example 1

A commercially available electronic-cigarette vaporization core has a porous body provided with a groove.

### Comparative Example 2

The material of the porous body of the electronic-cigarette vaporization core is the same as that of the first porous body in Example 1.

A difference lies in that the porous body in Comparative Example 2 is an integrally formed porous body.

Performance test

The following tests were carried out on the electronic-cigarette vaporization cores prepared in Examples 1-2 and Comparative Example 1-2.

Flatness test: 10 points were selected on the surface of the vaporization end of the electronic-cigarette vaporization core. Heights of the points were measured. A difference between a maximum value and a minimum value of the heights was used as flatness data.

Average resistance: 100 electronic-cigarette vaporization cores were collected and their resistance values were measured and averaged

Resistance range: The resistance range is obtained by subtracting the minimum resistance value from the maximum resistance value among the resistance values of the 100 electronic-cigarette vaporization cores.

Thickness range of electrically conductive heating circuit: The thickness of the electrically conductive heating circuit was measured. 10 points were selected. Thicknesses of the points were measured. A difference between a maximum value and a minimum value of the thicknesses was used as thickness range data.

Ceramic crushing strength: The electronic-cigarette vaporization core was placed on a sample table of a universal tester. Two parallel fixtures were used to squeeze the electronic-cigarette vaporization core until the electronic-cigarette vaporization core was broken. A force applied when the electronic-cigarette vaporization core was crushed was recorded.

The test results obtained are shown in Table 1.

TABLE 1

| | | | | | Thickness | |
|---|---|---|---|---|---|---|
| | | | | | range of | Ceramic |
| | Ceramic | | Average | Resistance | heating | crushing |
| Group | flatness | | resistor | range | circuit | strength |
| Example 1 | 50-80 | μm | 1.04 Ω | 0.13 Ω | 45 μm | 410N |
| Example 2 | 20-40 | μm | 0.96 Ω | 0.1 Ω | 30 μm | 460N |
| Comparative | 80-120 | μm | 1.0 Ω | 0.2 Ω | 50 μm | 200N |
| Example 1 | | | | | | |
| Comparative | 80-120 | μm | 1.1 Ω | 0.17 Ω | 60 μm | 490N |

Example 2

From the test results in Table 1, it can be seen that the electronic-cigarette vaporization core provided by the present disclosure can effectively improve the surface flatness of the porous body, and ensure that the surface flatness of the porous body is not more than 80 μm, the average resistance value is about 1.0 Ω, the resistance range is less than 0.13 Ω, and the thickness range of the heating circuit is not more than 45 μm. The arrangement of the porous body as a multi-layer embedding structure including the first porous body and the second porous body can improve the structural strength of the porous body, so that the ceramic crushing strength of the electronic-cigarette vaporization core provided by the present disclosure can reach 410 N or more.

In addition, it can be seen from the test data of Comparative Example 1 and Comparative Example 2 that the groove structure of the conventional electronic-cigarette vaporization core of Comparative Example 1 and the large deformation of the integrally formed porous body in Comparative Example 2, result in that the surface flatness of each of the electronic-cigarette vaporization cores of Comparative Example 1 and Comparative Example 2 is greater than 80 μm, the average resistance value is close to 1.1 Ω, the resistance range is greater than 0.17 Ω, and the thickness range of the heating circuit is greater than 50 μm. More importantly, in the conventional electronic-cigarette vaporization cores, the design of a single groove is adopted, and the ceramic crushing strength in Comparative Example 1 is only 200 N or more. In the present disclosure, the arrangement of the cross groove on the outer periphery of the central groove can effectively reduce the shrinkage stress difference between the inside and outside of the porous body, thereby ensuring the morphological stability of the electronic-cigarette vaporization core, ensuring the flatness of the electrically conductive heating circuit in the subsequent screen printing process, and improving the overall strength of the porous body.

Although some specific embodiments of this application have been described in detail by way of examples, a person skilled in the art should understand that the foregoing examples are only for description and are not intended to limit the scope of this application. A person skilled in the art should appreciate that modifications may be made to the foregoing embodiments without departing from the scope and spirit of this application. The scope of this application is limited only by the appended claims.

What is claimed is:

1. An electronic-cigarette vaporization core (100), comprising: a porous body and a heating element, the porous body comprising an e-liquid absorption end (200) and a vaporization end (300), and the heating element being arranged at the vaporization end (300) of the porous body;
the porous body comprising a first porous body (1) and a second porous body (2), a groove (11) being provided on a surface of the first porous body (1) close to the e-liquid absorption end (200), and the second porous body (2) being partially or completely embedded in the groove (11); and
a thermal shrinkage difference between the first porous body (1) and the second porous body (2) being less than 2%.

2. The electronic-cigarette vaporization core (100) according to claim 1, wherein the second porous body (2) is completely embedded in the groove (11) on the first porous body (1), the second porous body (2) matches the groove (11), and the second porous body (2) completely fills the groove (11).

3. The electronic-cigarette vaporization core (100) according to claim 1, wherein the thermal shrinkage difference between the first porous body (1) and the second porous body (2) is less than 0.5%.

4. The electronic-cigarette vaporization core (100) according to claim 1, wherein a thermal shrinkage of the first porous body (1) ranges from 1% to 22%, and a thermal shrinkage of the second porous body (2) ranges from 1% to 22%.

5. The electronic-cigarette vaporization core (100) according to claim 1, wherein the first porous body (1) and the second porous body (2) are identical porous ceramic bodies.

6. The electronic-cigarette vaporization core (100) according to claim 2, wherein the groove (11) comprises a central groove (111) and at least one cross groove (112) located on an outer side of the central groove (111), and the at least one cross groove (112) is communicated with the central groove (111).

7. The electronic-cigarette vaporization core (100) according to claim 6, wherein a quantity of the cross grooves (112) is two, and the two cross grooves (112) are symmetrically arranged on two sides of the central groove (111).

8. The electronic-cigarette vaporization core (100) according to claim 1, wherein the first porous body (1) is provided with an air guide channel, and the air guide channel is a through hole running through the first porous body (1) along an extending direction from the e-liquid absorption end (200) to the vaporization end (300).

9. The electronic-cigarette vaporization core (100) according to claim 1, wherein the first porous body (1) is provided with an air guide channel, the air guide channel is a through groove (12) arranged on an outer surface (1001) of the first porous body (1), and the through groove (12) runs through the first porous body (1) along an extending direction from an e-liquid absorption surface to a vaporization surface.

10. The electronic-cigarette vaporization core (100) according to claim 1, wherein a pore size of the first porous body (1) ranges from 5 μm to 100 μm, and a pore size of the second porous body (2) ranges from 5 μm to 100 μm; and
a porosity of the first porous body (1) ranges from 45% to 65%, and a porosity of the second porous body (2) ranges from 45% to 65%.

11. The electronic-cigarette vaporization core (100) according to claim 1, wherein a volume of the second porous body (2) accounts for 1%-70% of a total volume of the porous body.

12. The electronic-cigarette vaporization core (100) according to claim 1, wherein a volume of the second porous body (2) accounts for 3%-50% of a total volume of the porous body.

13. The electronic-cigarette vaporization core (100) according to claim 1, wherein the heating element comprises an electrically conductive heating circuit (3), a first electrode, and a second electrode, the electrically conductive heating circuit (3) is arranged on a surface of the vaporization end (300) of the porous body, and the first electrode and the second electrode are electrically connected to the electrically conductive heating circuit (3).

14. The electronic-cigarette vaporization core (100) according to claim 1, wherein a crushing strength of the electronic-cigarette vaporization core (100) is greater than or equal to 410 N.

15. An electronic cigarette, comprising an electronic-cigarette vaporization core (100) according to claim 1.

16. The electronic cigarette according to claim 15, further comprising a housing (101), an e-liquid storage bin (102), an upper bracket (103), a lower bracket (104), and a lower cover (105), wherein the upper bracket (103), the electronic-cigarette vaporization core (100), and the lower bracket (104) are arranged between the housing (101) and the lower cover (105), an outlet passage (1011) is arranged on the housing (101), an air exit hole (1031) communicated with the outlet passage (1011) and an e-liquid guide hole (1032) communicated with the e-liquid storage bin (102) are provided on the upper bracket (103), the electronic-cigarette vaporization core (100) is located between the upper bracket (103) and the lower bracket (104), the e-liquid storage bin (102) is communicated with the e-liquid absorption end (200) of the porous body through the e-liquid guide hole (1032), a vaporization chamber (106) is formed between the vaporization end (300) of the porous body and the lower bracket (104), the lower cover (105) is located on a side of the lower bracket (104) away from the electronic-cigarette vaporization core (100), an air intake hole (1051) is provided on the lower cover (105), and the air intake hole (1051) is communicated with the air exit hole (1031) through the vaporization chamber (106).

17. The electronic cigarette according to claim 16, further comprising an upper-bracket sealing element (107), a vaporization-core sealing element (108), and a lower-cover sealing element (109), wherein the upper-bracket sealing element (107) is sleeved on an outer periphery of the upper bracket (103), an outer edge of the upper-bracket sealing element (107) abuts against an inner wall of the housing (101) to define the e-liquid storage bin (102), the upper-bracket sealing element (107) is provided with a first communication hole (1071) for communicating the e-liquid storage bin (102) with the e-liquid guide hole (1032), and the upper-bracket sealing element (107) is provided with a second communication hole (1072) for communicating the outlet passage (1011) with the air exit hole (1031); the vaporization-core sealing element (108) is sleeved on an outer periphery of the electronic-cigarette vaporization core (100); and the lower-cover sealing element (109) is arranged around an outer periphery of the lower cover (105), and an outer edge of the lower-cover sealing element (109) abuts against an inner wall of the housing (101).

18. The electronic cigarette according to claim 15, wherein the second porous body (2) is completely embedded in the groove (11) on the first porous body (1), the second porous body (2) matches the groove (11), and the second porous body (2) completely fills the groove (11).

19. The electronic cigarette according to claim 15, wherein the thermal shrinkage difference between the first porous body (1) and the second porous body (2) is less than 0.5%.

20. The electronic cigarette according to claim 15, wherein a thermal shrinkage of the first porous body (1) ranges from 1% to 22%, and a thermal shrinkage of the second porous body (2) ranges from 1% to 22%.
